(19) United States
(12) Patent Application Publication
(10) Pub. No.: US 2020/0141757 A1
(43) Pub. Date: May 7, 2020

(54) MAP INFORMATION CREATION DEVICE, MAP INFORMATION CREATION METHOD, MAP INFORMATION CREATION PROGRAM, AND RECORDING MEDIUM

(71) Applicants: Toyota Mapmaster Incorporated, Nagoya-shi (JP); Toyota Jidosha Kabushiki Kaisha, Toyota-shi (JP)

(72) Inventors: Satoru Deguchi, Nagoya-shi (JP); Kenta Nakanishi, Nagoya-shi (JP); Xin Jin, Toyota-shi (JP)

(21) Appl. No.: 16/527,404

(22) Filed: Jul. 31, 2019

(30) Foreign Application Priority Data
Nov. 2, 2018 (JP) 2018-207683

(51) Int. Cl. G01C 21/36; G06F 16/29

(52) U.S. Cl. CPC G01C 21/3679; G06F 16/29

(57) ABSTRACT

A map information creation device includes a storage unit that stores map information including POI information related to points of interest (POI), and a POI learning model that extracts information indicating events or topics regarding the POI from input data, an input unit that receives an input of an information group including a document, an extraction unit that extracts information indicating events or topics regarding one or more POI from the information group using the POI learning model, a specifying unit that specifies new information not included in the POI information in the information extracted by the extraction unit, a registration unit that registers the new information as new information on the POI in the POI information, and a setting unit that sets an expiration period of the new information specified by the registration unit.

### TECHNICAL FIELD

This disclosure relates to a map information creation device capable of specifying information indicating an event or topic regarding a POI (point(s) of interest) from various types of information and setting the information on a map, a map information creation method, a map information creation program, and a recording medium having the program recorded thereon.

### BACKGROUND

Information related to points of interest (POI) indicating places or facilities in which a user is likely to be interested is registered in map information used in a navigation system. The information on the POI refers to all pieces of information on the POI, and may include information indicating features of the POI (for example, a kind of genre of food provided in a restaurant), in addition to a name and the location of the POI. Basically, the pieces of information on the POI are input and registered manually by an operator creating map information one by one. However, since work therefor becomes enormous, automation of a process is desired. Therefore, Japanese Unexamined Patent Application Publication No. 2017-182818 discloses a way to extract facility information by accessing a URL of original information available on an information distribution site and scraping source code of a website indicated by the URL. Further, Japanese Unexamined Patent Application Publication No. 2016-24545 discloses a way to extract event information including an event name and a corresponding event holding location name from a plurality of pieces of posted information.

When the methods described in Japanese Unexamined Patent Application Publication No. 2017-182818 and Japanese Unexamined Patent Application Publication No. 2016-24545 are used, there is a likelihood that information on the POI can be extracted and related event information can be extracted. Although it is possible to automatically register the extracted information as information on the POI, and the information extracted in this way can have a guarantee of being highly current, the information cannot be said to be necessarily appropriate as the POI information of the map information. Thus, when incorrect information is registered as the POI information, there is a problem that information with deficiencies is posted as map information and, thus, a navigation system is likely to provide incorrect information to a user.

Therefore, it could be helpful to provide a map information creation device capable of eliminating deficiencies even when information with deficiencies is registered, a map information creation method, and a map information creation program to solve the above-mentioned problems.

### SUMMARY

We provide a map information creation device including a storage unit that stores map information including POI information related to points of interest (POI), and a POI learning model that extracts information indicating events or topics regarding the POI from input data; an input unit that receives an input of an information group including a document; an extraction unit that extracts information indicating events or topics regarding one or more POI from the information group using the POI learning model; a specifying unit that specifies new information not included in the POI information in the information extracted by the extraction unit; a registration unit that registers the new information as new information on the POI in the POI information; and a setting unit that sets an expiration period of the new information specified by the registration unit.

We also provide a map information creation method executed by a map information creation device including a storage unit that stores map information including POI information related to points of interest (POI), and a POI learning model that extracts information indicating events or topics regarding the POI from input data, the map information creation method including: an input step of receiving an input of an information group including a document; an extraction step of extracting information indicating events or topics regarding one or more POI from the information group using the POI learning model; a specifying step of specifying new information not included in the POI information in the information extracted in the extraction step; a registration step of registering the new information as new information regarding content of the POI in the POI information; and a setting step of setting an expiration period of the new information specified in the registration step.

We further provide a map information creation program that causes a computer capable of accessing a storage function of storing map information including POI information related to points of interest (POI), and a POI learning model that extracts information indicating events or topics regarding the POI from input data, to realize: an input function of receiving an input of an information group including a document; an extraction function of extracting information indicating events or topics regarding one or more POI from the information group using the POI learning model; a specifying function of specifying new information not included in the POI information in the information extracted using the extraction function; a registration function of registering the new information as new information regarding content of the POI in the POI information; and a setting function of setting an expiration period of the new information specified using the registration function.

The extraction unit may calculate a probability indicating whether or not extracted information is valid as the information on the POI when extracting the information indicating events or topics regarding the one or more POI, and the setting unit may set the expiration period on the basis of the probability.

The setting unit may set the expiration period on the basis of a frequency at which the new information has been extracted from the information group.

The setting unit may set the expiration period to be long when information sources from which the new information has been extracted in the information group is extracted from two or more different information sources.

The map information creation device may further include a determination unit that determines whether or not the new information is continuous information as information, wherein the setting unit may not set the expiration period for the new information when the determination unit determines that the new information is continuously extracted information.

The registration unit may invalidate the new information when an expiration period has elapsed, the expiration period having been set for the new information.

It is possible to register information indicating new events or topics in the POI, and set the expiration period in which the information is valid on the basis of a likelihood of the information being incorrect information. Therefore, even when incorrect information is registered, the information is invalidated after the expiration period has elapsed. Accordingly, the map information creation device can compensate for deficiencies even when information with deficiencies is registered.

### BRIEF DESCRIPTION OF THE DRAWINGS

FIG. 1 is a block diagram illustrating an example of a functional configuration of a map information creation device.

FIG. 2 is a data conceptual diagram illustrating an example of a data configuration of POI information.

FIG. 3 is a data conceptual diagram illustrating an example of a data configuration of POI information updated by the map information creation device.

FIG. 4 is a flowchart illustrating an operation of the map information creation device.

FIG. 5 is an image diagram illustrating creation of a POI learning model and a flow of a determination.

FIG. 6 is a block diagram illustrating another configuration example of the map information creation device.

### REFERENCE SIGNS LIST

100 Map information creation device

101 Input unit

103 Output unit

104 Storage unit

105 CPU (extraction unit, specifying unit, registration unit, setting unit)

### DETAILED DESCRIPTION

Hereinafter, a map information creation device according to an example will be described in detail with reference to the drawings.

### EXAMPLE

### Configuration of Map Information Creation Device

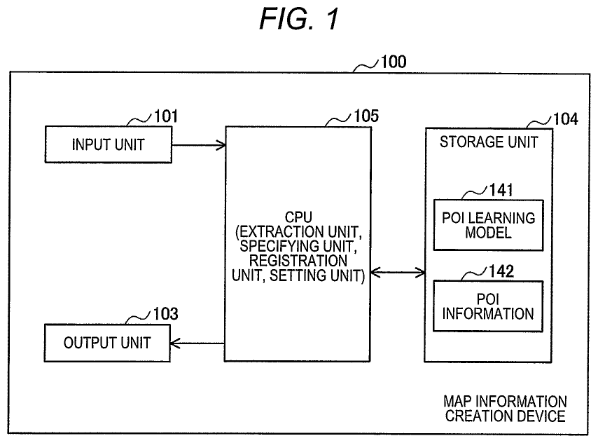

As shown in FIG. 1, a map information creation device includes a storage unit 104 that stores map information including POI information related to POI, and a POI learning model that extracts information indicating events or topics regarding the POI from input data, an input unit 101 that receives an input of an information group including a document, a CPU 105 including an extraction unit that extracts information indicating events or topics regarding one or more POI from the information group using the POI learning model, a specifying unit that specifies new information not included in the POI information in the information extracted by the extraction unit, a registration unit that registers new information as new information on the POI in the POI information, and a setting unit that sets an expiration period of the new information specified by the registration unit.

The POI refers to places, facilities or the like in which the user seems to be interested. Further, information indicating events or topics regarding the POI may be any information as long as the information is information from which a state of the POI can be understood with respect to the POI. Examples of the information may include a change in state of the POI (for example, renovation or closing of a store), a service executed by the POI or a change therein, a time-limited service provided by the POI, and popularity and the topics of the POI.

FIG. 1 is a block diagram illustrating an example of a functional configuration of the map information creation device 100. As illustrated in FIG. 1, the map information creation device 100 includes an input unit 101, an output unit 103, a storage unit 104, and a CPU 105.

The map information creation device 100 acquires, for example, information on events or topics of various POI included in a map to be used by a navigation system from various pieces of document information. Since an operator does not have to search for information to be registered as POI information by the map information creation device 100 acquiring the events or topics of the POI, processing by the operator is reduced. Further, the map information creation device 100 can register information on the POI, that is, information on events or topics of the POI as tag information, and can provide an expiration period for the tag information. Hereinafter, respective functional units of such a map information creation device 100 will be described in detail.

The input unit 101 has a function of receiving an input from the user of the map information creation device 100 and transferring the input to the CPU 105. The input unit 101 can be realized by, for example, a hardware key or a soft key such as a touch key included in the map information creation device 100. The input unit 101 receives, for example, an input of document information that is a target of a determination (specifying) of the events or topics of the POI from the operator. The input unit 101 transfers document information indicating content of the received input to the CPU 105. The input to the input unit 101 may be voice input. In a voice input, for example, the input unit 101 may input a document including POI information in an aspect in which the operator reads the document. Further, the input unit 101 may also serve as a communication interface to receive information from another device, and may receive an input of an information group including a document as a document group that is a determination target.

The output unit 103 has a function of outputting instructed data according to an instruction from the CPU 105. The output unit 103 functions as a communication interface that outputs information designated by the CPU 105 to an external device. The output unit 103, for example, can output data to an external device such as a monitor or a speaker, for example. The output unit 103 outputs, for example, information indicating the events or topics of the POI that the CPU 105 has found from the document.

The storage unit 104 is a recording medium that stores various programs necessary for the map information creation device 100 to operate, and various pieces of data including map information. The storage unit 104 is realized by, for example, a hard disc drive (HDD) or a solid state drive (SSD). The storage unit 104 stores a POI learning model 141 and POI information 142. These pieces of information may be stored in the storage unit 104 in advance. The POI learning model 141 may be a POI learning model in which a model obtained as a result of learning in the map information creation device 100 is stored. The POI learning model 141 is a model capable of specifying a word related to events or topics regarding the POI when a document (text data) serving as a determination target is input and a word regarding the events or topics regarding the POI is included in the text data. The POI learning model 141 is a model that learns what information the events or topics related to the POI are in the input information and which POI the events or topics correspond to, and is a so-called model capable of performing an estimation process in deep learning. The POI information 142 is a database including various types of information on the POI. Details of the POI information 142 will be described below.

The CPU 105 is a processor that executes a process to be executed by the map information creation device 100 using various programs and various pieces of data stored in the storage unit 104.

The CPU 105 inputs the information group transferred from the input unit 101 to the POI learning model 141. Using the POI learning model 141, the CPU 105 has a function of specifying, using the POI learning model 141, whether a word regarding the events or topics regarding the POI is included in the transferred information group, what are the events or topics when the word is included, and which POI the word corresponds to.

Further, the CPU 105 determines whether the specified word is new information. When the word is new information, the CPU 105 further determines whether the information is continuous information. When the word is not new information, the CPU 105 does nothing. When the word is new information, the CPU 105 determines whether or not the information determined to be new is continuously extracted information in an input information group.

When the information is continuously extracted information, the CPU 105 registers the new information as new tag data in tag data 215 of the POI information 142 to be described below. On the other hand, also when the information is not continuously extracted information, the CPU 105 registers the new information as new tag data in the tag data 215. However, in this example, the CPU 105 calculates an expiration period of the tag data and registers the calculated expiration period in an expiration period 217 in association with the tag data. Further, the CPU 105 also registers a date and time when the registration has been performed, in a registration date 216.

Further, when there is the tag data 215 of which the expiration period 217 has elapsed after the registration date 216 in the POI information 142, the CPU 105 invalidates the tag data. Invalidation of the tag data may be that information (flag) indicating that the tag data is invalidated is associated with the POI information 142 or may be that the information is deleted from the POI information 142. The content of the tag data can be used to search the POI and the like, but in this example, when information indicating that the tag data is invalid is associated therewith, the tag data is not used for searching the POI.

The above is an example of a configuration of the map information creation device 100. Data

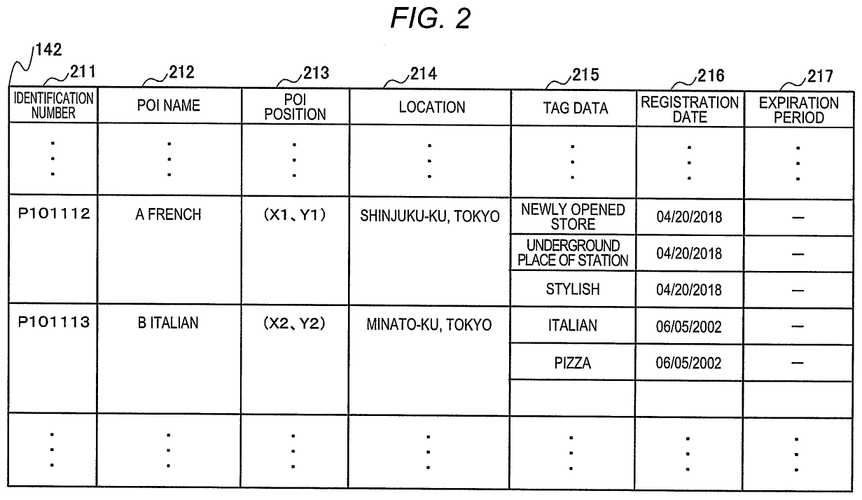

FIG. 2 is a data conceptual diagram illustrating a configuration example of the POI information 142 stored in the storage unit 104 of the map information creation device 100.

As illustrated in FIG. 2, the POI information 142 is information in which an identification number 211, a POI name 212, a POI position 213, a location 214, tag data 215, the registration date 216, and the expiration period 217 are associated.

The identification number 211 is identification information set so that the map information creation device 100 can uniquely specify each POI in the POI information 142.

The POI name 212 is information indicating a name of the corresponding POI, and corresponds to a store name, a facility name, a place name or the like.

The POI position 213 is information indicating position coordinates of the corresponding POI, and indicates longitude and latitude information thereof. This longitude and latitude information may be position coordinates of a center of a site of the corresponding POI, may be position coordinates of any place within the site, or may be position coordinates indicating a range of the entire site of the POI.

The location 214 is information indicating a location of the corresponding POI, and indicates an address. This address may be information indicating only an approximate place.

The tag data 215 is information related to the corresponding POI, and is information such as a feature, a state, events or topics in the POI. The tag data 215 is managed separately for each piece of associated information.

The registration date 216 is information indicating a date when the corresponding tag data 215 is registered in the POI information 142.

The expiration period 217 is information indicating an expiration period of the corresponding tag data 215. The expiration period 217 is information indicating a validity from the corresponding registration date 216 and is indicated by a number of days. The expiration period 217 may be information indicating an expiration date. In the example of FIG. 2, a date obtained by adding the number of days indicated by the expiration period to the registration date 216 is the expiration date. Further, the expiration period 217 is not set when there is no time limit, and in FIG. 2, when the expiration period is not set, the expiration period is expressed by “-”.

In the example of FIG. 2, it can be understood that a name of the POI having the identification number 211 of “P101112” is “A French”, a position of the POI has coordinates “(X1, Y1)”, a residence is at “Shinjuku-ku, Tokyo”, information such as “newly opened store”, “underground place of station”, and “stylish” is associated as tag data 215, and a registration date of these pieces of information is “Apr. 20, 2018”. Further, it can be understood that no expiration period is set for each piece of tag data of “A French”.

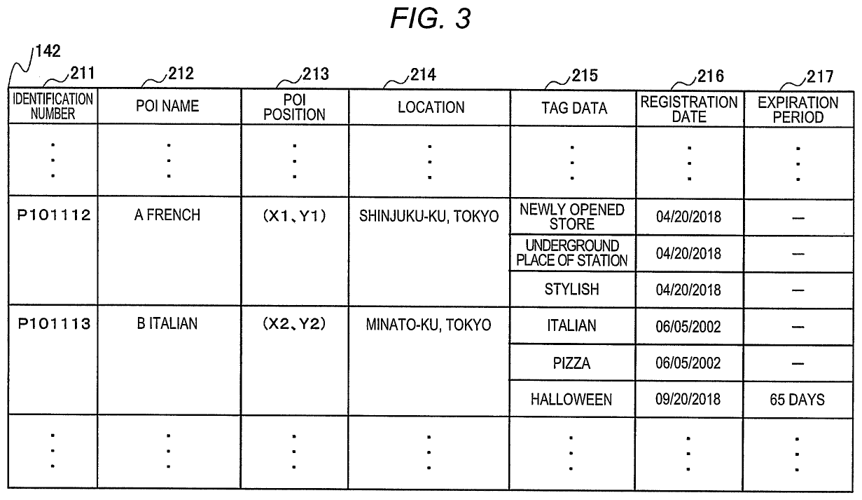

FIG. 3 illustrates an example of the POI information 142 updated by the map information creation device 100.

When new information is included in the input information group, the map information creation device 100 newly registers the new information in the POI information 142 together with the expiration period calculated according to the calculated probability when extracting the new information.

In the example in FIG. 3, an example is shown in which a word “Halloween” is extracted as a word related to events or topics regarding the POI for the POI, B Italian, and newly registered in the tag data 215.

An expiration period “65 days” is set in association with the tag data “Halloween”. Thus, when information on the events or topics regarding the POI extracted by the map information creation device 100 has been newly registered, the expiration period is set. By setting this expiration period, since the newly registered tag data is invalidated when the expiration period has elapsed even when the content of the newly registered tag data for the POI information is incorrect, the POI information 142 included in the map information 142 is automatically corrected. Operation of map information creation device

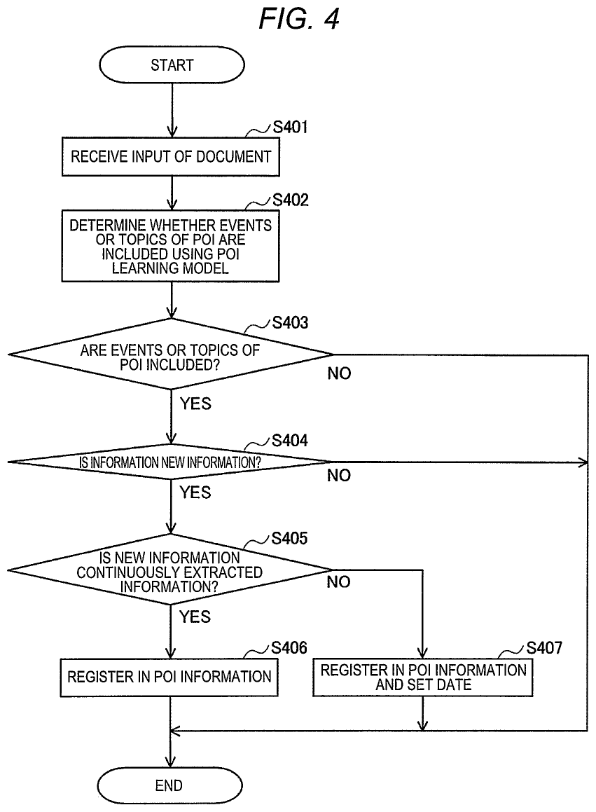

FIG. 4 is a flowchart illustrating a process of specifying the events or topics of the POI and registering the events or topics in the POI information 142 when the content of the events or topics is new information in the map information creation device 100.

As illustrated in FIG. 4, the input unit 101 of the map information creation device 100 receives the input of the document (step S401). This document preferably includes events or topics regarding the POI on a network, and a document collected from, for example, blogs, TWITTER (registered trademark), net news, or websites (home pages) may be input. For information thereof, information automatically collected by the map information creation device 100 by traveling around the network may be used or information collected by an operator of the map information creation device 100 may be used. The input unit 101 transfers the input information to the CPU 105.

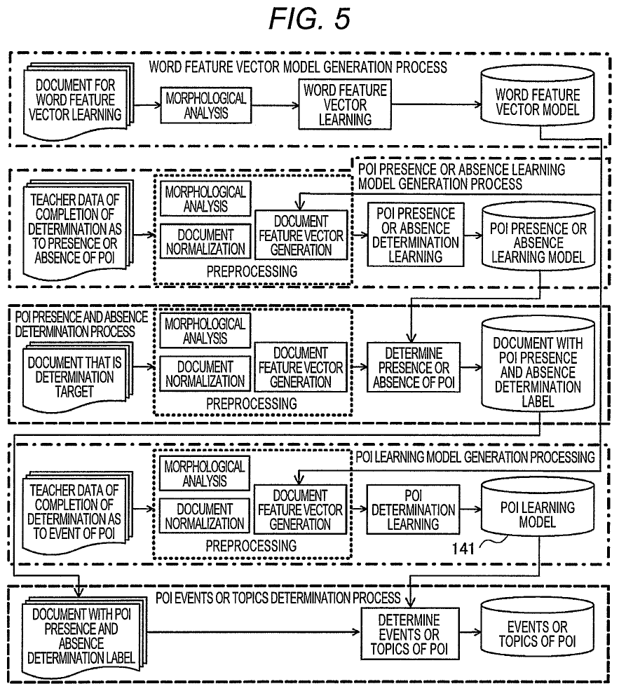

The CPU 105 determines whether the events or topics of the POI are included in the transferred information group using the POI learning model 141 (step S402). The CPU 105 determines and specifies an event or topic at a certain POI. Although one specific example is illustrated in the configuration illustrated in FIG. 5, it is first determined whether or not information on the POI is included in the document, information capable of specifying the POI can be extracted from a document determined to include information on the POI, and information on the POI is extracted through context analysis. As an example, it is determined that no POI is included in a document “there is a good place in Nagoya”. On the other hand, a POI “restaurant A” is included in a document such as “∘∘ of restaurant A in Nagoya is delicious”, and information “∘∘ is delicious” can be extracted as an event or topic (a candidate for new information). A POI “store B” is included in a document such as “Now, store B treats □□”, and information “treats □□” can be extracted as an event or topic. This is realized by first determining whether or not the document is a document regarding a specific POI and extracting information on the specific POI from the document determined to be a document regarding the specific POI. That is, the specific POI may be specified first or the specific POI may be specified later.

When it is determined that events or topics of the POI are included (YES in step S403), the CPU 105 determines whether or not the information is new information for the corresponding POI (step S404). A determination can be made as to whether or not the information is new information on the basis of whether the word specified as the events or topics of the POI has already been registered as the tag data 215 of the corresponding POI in the POI information 142. Further, the POI to which the new information corresponds is specified by analyzing a context using morphological analysis for a document that is an extraction target. As an example, when there is a document such as “store A is holding a limited-time event with the support of company B”, “store A” is the corresponding POI when the “limited-time event” can be extracted as the new information.

When the information on the events or topics of the POI extracted from the information group input by the CPU 105 is new information (YES in step S404), the CPU 105 determines whether or not the new information is continuously extracted information (step S405). Continuously extracted information refers to information that appears frequently in the input information group, which is information of which a period of time (a period) in which the information appears in the input information group is longer than a predetermined value. The period of time in which the information appears in the input information group can be specified on the basis of a date and time when each piece of information has been posted.

Further, the period of time in which the information appears being longer than a predetermined time means that date and time information of an article in which the information specified as the events or topics of the POI are published (for example, a date and time when the article has been posted or a date and time related to the article included in the article) spans a certain period of time. That is, the period of time in which the information appears being longer than a predetermined time means that information on the events or topics of the POI can be extracted for the POI for a certain period of time (for example, half a year).

When it is determined that the information on the events or topics of the POI extracted by the CPU 105 is continuously extracted information (YES in step S405), the CPU 105 registers the extracted word as permanent tag data of the corresponding POI in the tag data 215 (step S406) and ends the process.

On the other hand, when it is determined that the new appearing information is not continuously extracted information (NO in step S405), the CPU 105 registers the information determined not to be the continuously extracted information, in the tag data 215 of the POI information 142.

Further, in this example, the CPU 105 calculates an expiration period according to the probability with which it is determined that the extracted words are an event or topic of the corresponding POI. The CPU 105 registers the calculated expiration period in the POI information 142 in association with the corresponding tag data 215 (step S407), and ends the process.

The CPU 105 registers the registration date 216 together in the registration of the tag data 215, but for this date and time, the latest date and time when information from which corresponding tag data can be extracted has been posted (posted on the web) is registered. This date and time may be replaced with a date and time when the map information creation device has extracted new information.

Further, when the event or topic of the POI cannot be specified (NO in step S403) or when the event or topic of the POI can be specified, but the information is not new (NO in step S404), the process ends.

Thus, the map information creation device 100 can specify events or topics regarding the POI from the input new information and register the event or topic as POI information of the map information. Further, in this example, the map information creation device 100 can prepare and set the expiration period for the information to be registered, thereby preventing damage when the registered information is erroneous from increasing. Image of learning and determination in map information creation device

FIG. 5 is an image diagram illustrating learning using the map information creation device 100, a flow of a determination using results of learning, and a way of using a learned model. In FIG. 5, a process in a range enclosed by a one-dot chain line corresponds to a learning process, and a process in an area enclosed by a dashed line corresponds to a determination process. The process in the area surrounded by the dotted line corresponds to preprocessing in the learning process.

A word feature vector model can be generated by performing morphological analysis on an input of a document for feature vector learning of a word and learning the feature vector of the word as illustrated in FIG. 5. As illustrated in FIG. 5, the word feature vector model can be used in a stage of any of learning of the presence or absence of the POI and learning of the events or topics of the POI. For example, information such as an electronic dictionary or Wikipedia on a network can be used for a document to learn the feature vector of the word. Further, fasttext can be used as an example of learning the feature vector of the word. Fasttext is a library (a neural network) for machine learning that supports word vectorization and text classification. Fasttext is just an example, and learning may be performed using other resources.

Further, the map information creation device 100 can generate a POI presence and absence learning model by learning the presence or absence of the POI after performing preprocessing such as morphological analysis, document normalization, and document feature vector generation on teacher data of a determination as to the presence or absence of the POI. The morphological analysis is to analyze a document and decompose the document into morphemes (elements). Normalization of the document is to correct how words are used in the document (a fluctuation of expressions) (or recognize a fluctuating word as the same word) or perform shaping into a format suitable for generation of a feature vector of the document.

In FIG. 5, a feature vector of a document is generated by performing preprocessing, and the presence or absence of the POI can be learned, for example, using a random forest with respect to the generated feature vector of the document.

The random forest is a type of machine learning algorithm, and creates a predetermined number (for example, one thousand types) of models for a determination from combinations of randomly sampled teacher data. The random forest is a learning model to obtain a final determination result by the majority of determination results using all the created models for a determination at the time of a determination. Therefore, the random forest can also output a determination result for the document with probability from each learning (determination) model. In this example, the feature vector of the document generated from each of the input teacher data of completion of a determination as to the presence or absence of the POI is randomly sampled, thereby generating a determination model as the POI presence and absence learning model. The teacher data of completion of a determination as to the presence or absence of the POI is information for which a determination has already been manually made as to whether or not the information on the POI is included in the document, and is information with which a flag information indicating the presence or absence of the POI is associated. As illustrated in FIG. 5, the POI presence and absence learning model is used when a POI presence and absence determination process of determining whether or not information on the POI is included in the input information is performed on the input information.

Further, the map information creation device 100 can generate the POI learning model 141 by performing preprocessing such as morphological analysis, document normalization, and document feature vector generation on teacher data of completion of a determination for events or topics of the POI and, then, learning the events or topics of the POI. The teacher data of completion of a determination as to the events or topics of the POI are information with which information indicating an event or topic regarding a certain POI in the content of the information is associated. The random forest can be used for learning of the events or topics of the POI.

In specifying the events or topics of the POI, the map information creation device 100 first receives the input of the document (information group) that is a determination target and determines whether each document in the information group is related to the POI using the POI presence and absence learning model, as illustrated in FIG. 5. As a result of the determination, a document with a POI presence and absence determination label is obtained.

Then, the map information creation device 100 specifies the event or topic of the POI using the POI learning model 141 for a document group determined to include the information on the POI in the presence or absence of the POI in the information groups that are determination targets. The CPU 105 calculates the probability of the wording indicating the specified event or topic as the tag data, calculates the expiration period using the probability, and registers the expiration period in the POI information 142.

As described above, when the POI learning model 141 is generated using the random forest, a plurality of (for example, one thousand) determination models can be included, and output results from the respective determination models can be obtained. That is, for one piece of input information, a plurality of pieces (for example, a thousand pieces) of information specified as the events or topics of the POI are output from the input information.

In the output results, information with the largest amount is regarded as the events or topics of the POI and specified as a wording to be registered as the tag data 215. In this example, the CPU 105 of the map information creation device 100 determines a degree to which the determination model has output the output results among all the output results in the wording as probability of the wording. The CPU 105 calculates an expiration period of the wording using the calculated probability. For example, it is assumed that an event or topic “long line” can be specified as an event of a POI for “A French” serving as a POI from a certain document in one thousand determination models. It is assumed that the number of determination models that have output a combination of “A French” and “long line” is K. In this example, K/1000 can be used as the probability for the wording “long line” calculated by the CPU 105. The CPU 105 can set, for example, a value obtained by multiplying a value of K/1000 by a predetermined coefficient (for example, 100), as the number of days of the expiration period. When K is 400, the wording “long line” is registered as the tag data 215 of A French, and “40 days” is registered as the expiration period 217. Further, for the registration date 216, the latest date on which information sources from which the wordings A French and the long line can be extracted are registered on a web can be used.

In another specific example, it is assumed that information “Halloween” when information group having content “Halloween party with an B Italian” or “B Italian received Halloween award from Company D” is input can specify that there is an event or topic for the POI “B Italian”. It is assumed that 600 determination models among one thousand determination models have specified “Halloween”. In this example, the probability of a wording “Halloween” as the tag data can be calculated as 600/1000=0.6. It is possible to set an initial value (for example, 30 days) as the expiration period in advance, and set a value obtained by multiplying the initial value by a value obtained by performing the predetermined computation on the calculated probability, as the expiration period. For example, when computation of adding one to the calculated probability is performed as predetermined computation, the number of days, (0.6+1)×30=48 days, can be calculated as the expiration period.

Further, the expiration period may be calculated (corrected) using a frequency indicating how many times the wording “Halloween” has appeared in the input information group. When the frequency is higher, the expiration period is set to be long, and when the frequency is lower, the expiration period is set to be short. For example, the frequency can be a value obtained by dividing the specified wording by the total number of information groups, a value obtained by multiplying the expiration period calculated using the above-described scheme by the frequency can be used as a final expiration period.

Further, the expiration period may be set (corrected) according to a type of information source (net news, blog, TWITTER, website, newspaper, . . . ) in which the wording “Halloween” can be specified. That is, as the number of types of information sources is larger, the expiration period is set to be long, and as the number of types of information sources is smaller, the expiration period is set to be short. As an example, when the number of types of information source is one, the expiration period calculated by the above-described scheme is used as it is, when the number is two, the expiration period is increased by 20%, and when the number is three, the expiration period is increased by 30%. Thus, it is possible to extend the expiration period.

A method of calculating the expiration period is not limited to the above-described calculation method, and another calculation method may be appropriately used so that the expiration period becomes a period having an appropriate length. In this calculation, it is only necessary to use the probability as an event or topic of a wording as an input variable.

Although the screening is first made as to whether or not information on the POI itself is included in the input information group in FIG. 5, information input to the input unit 101 may be input to the POI learning model 141 as it is. However, it is possible to increase a likelihood of more accurate information being obtained by screening whether or not the information on the POI is included in the information in the POI presence and absence learning model in advance.

With the map information creation device 100, it is possible to specify the information on the POI, which is the information on the events or topics of the POI, from among various types of information collected from the network or the like, and register the information as the POI information. Further, in this example, the expiration period is set on the basis of the probability of the extracted information as the tag data of the POI. Accordingly, the map information creation device can correct an error of the tag data by invalidating the tag data after the expiration period even when the tag data is incorrect as the POI information.

### Supplement

It is apparent that the map information creation device is not limited to the above example and may be realized using another configuration. Hereinafter, various modification examples will be described.

(1) In the above configuration, the example in which new tag data and the expiration period thereof are set for the POI information for use in the map information used for navigation has been described, but the registration of the tag data and the setting of the expiration period are not limited to the POI information for use in the map information of the navigation system as a target. The target may be a registration destination other than the POI information for the map information of the navigation system. The example may be applied to any database as long as the database includes information on the POI and tag data is registered as the information on the POI.

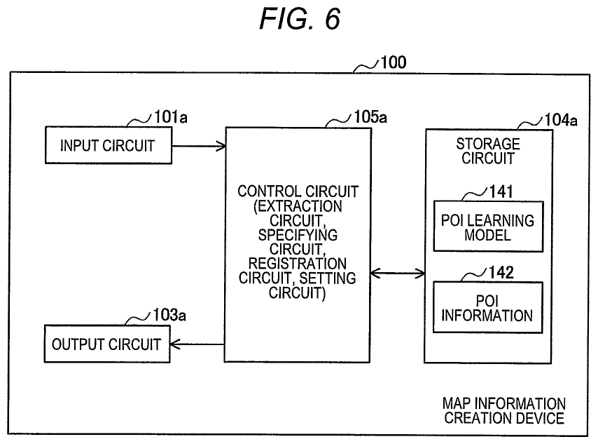

(2) Although, as a means of specifying the events or topics of the POI from the document in the map information creation device and registering the topics in the POI information, the processor of the map information creation device executes the map information creation program or the like to register the topics, the registration may be realized by a logical circuit (hardware) formed of an integrated circuit (an integrated circuit (IC) chip, large scale integration (LSI)) or the like, or a dedicated circuit in the device. Further, these circuits may be realized by one or a plurality of integrated circuits, or functions of the plurality of functional units illustrated in the above example may be realized by one integrated circuit. The LSI may be called VLSI, super LSI, ultra LSI or the like according to an integration difference. That is, the map information creation device 100 may include an input circuit 101a, an output circuit 103a, a memory circuit 104a, and a control circuit 105a that correspond to the input unit 101, the output unit 103, the storage unit 104, and the CPU 105, respectively, as illustrated in FIG. 6.

Further, the map information creation program may be recorded on a processor-readable recording medium, and a “non-transitory tangible medium” such as a tape, a disk, a card, a semiconductor memory, or a programmable logic circuit may be used as the recording medium. Further, the map information creation program may be supplied to the processor via an arbitrary transmission medium (such as a communication network or broadcast waves) capable of transmitting the map information creation program. That is, for example, a configuration in which the map information creation program may be downloaded and executed from the network using an information processing device such as a smartphone may be adopted. Our devices and methods can also be realized in the form of a data signal in carrier waves, in which the map information creation program is implemented by electronic transmission.

The map information creation program may be installed using, for example, a script language such as ActionScript or JAVASCRIPT (registered trademark), an object-oriented programming language such as Objective-C, JAVA (registered trademark) or C++, or a markup language such as HTML5.

(3) The various examples illustrated in the above configuration or the various examples illustrated in “Supplement” may be combined appropriately. Further, in each operation illustrated in each flowchart, an execution order may be replaced or executed in parallel when there is no contradiction as a result.

What is claimed is:

1. A map information creation device comprising:
a storage unit that stores map information including POI information related to points of interest (POI), and a POI learning model that extracts information indicating events or topics regarding the POI from input data;
an input unit that receives an input of an information group including a document;
an extraction unit that extracts information indicating events or topics regarding one or more POI from the information group using the POI learning model;
a specifying unit that specifies new information not included in the POI information in the information extracted by the extraction unit;
a registration unit that registers the new information as new information on the POI in the POI information; and
a setting unit that sets an expiration period of the new information specified by the registration unit.

2. The map information creation device according to claim 1, wherein the extraction unit calculates probability indicating whether or not extracted information is valid as the information on the POI when extracting the information indicating events or topics regarding the one or more POI, and
the setting unit sets the expiration period based on the probability.

3. The map information creation device according to claim 1, wherein the setting unit sets the expiration period based on a frequency at which the new information has been extracted from the information group.

4. The map information creation device according to claim 1, wherein the setting unit sets the expiration period to be long when information sources from which the new information has been extracted in the information group is extracted from two or more different information sources.

5. The map information creation device according to claim 1, further comprising:
a determination unit that determines whether or not the new information is continuous information as information,
wherein the setting unit does not set the expiration period for the new information when the determination unit determines that the new information is continuously extracted information.

6. The map information creation device according to claim 1, wherein the registration unit invalidates the new information when an expiration period has elapsed, the expiration period having been set for the new information.

7. A map information creation method executed by a map information creation device including a storage unit that stores map information including POI information related to points of interest (POI), and a POI learning model that extracts information indicating events or topics regarding the POI from input data, the map information creation method comprising:
an input step of receiving an input of an information group including a document;
an extraction step of extracting information indicating events or topics regarding one or more POI from the information group using the POI learning model;
a specifying step of specifying new information not included in the POI information in the information extracted in the extraction step;
a registration step of registering the new information as new information regarding content of the POI in the POI information; and
a setting step of setting an expiration period of the new information specified in the registration step.

8. The map information creation method according to claim 7, wherein the extraction step includes calculating probability indicating whether or not extracted information is valid as the information on the POI when extracting the information indicating events or topics regarding the one or more POI, and
the setting step includes setting the expiration period on the basis of the probability.

9. The map information creation method according to claim 7, wherein the setting step includes setting the expiration period based on a frequency at which the new information has been extracted from the information group.

10. The map information creation method according to claim 7, wherein the setting step includes setting the expiration period to be long when information sources from which the new information has been extracted in the information group is extracted from two or more different information sources.

11. The map information creation method according to claim 7, further comprising:
a determination step that determines whether or not the new information is continuous information as information,
wherein the setting step includes not setting the expiration period for the new information when it is determined in the determination step that the new information is continuously extracted information.

12. The map information creation method according to claim 7, wherein the registration step includes invalidating the new information when an expiration period has elapsed, the expiration period having been set for the new information.

13. A map information creation program that causes a computer capable of accessing a storage function of storing map information including POI information related to points of interest (POI), and a POI learning model that extracts information indicating events or topics regarding the POI from input data, to realize:
an input function of receiving an input of an information group including a document;
an extraction function of extracting information indicating events or topics regarding one or more POI from the information group using the POI learning model;
a specifying function of specifying new information not included in the POI information in the information extracted using the extraction function;
a registration function of registering the new information as new information regarding content of the POI in the POI information; and
a setting function of setting an expiration period of the new information specified using the registration function.

14. The map information creation program according to claim 13, wherein the extraction function includes calculating probability indicating whether or not extracted information is valid as the information on the POI when extracting the information indicating events or topics regarding the one or more POI, and
the setting function includes setting the expiration period on the basis of the probability.

15. The map information creation program according to claim 13, wherein the setting function includes setting the expiration period on the basis of a frequency at which the new information has been extracted from the information group.

16. The map information creation program according to claim 13, wherein the setting function includes setting the expiration period to be long when information sources from which the new information has been extracted in the information group is extracted from two or more different information sources.

17. The map information creation program according to claim 13, further comprising:
a determination function of determining whether or not the new information is continuous information as information,
wherein the setting function includes not setting the expiration period for the new information when it is determined using the determination function that the new information is continuously extracted information.

18. The map information creation method according to claim 13, wherein the registration function includes invalidating the new information when an expiration period has elapsed, the expiration period having been set for the new information.

19. A non-transitory computer readable recording medium having the map information creation program according to claim 13 recorded thereon.
